(19) United States
(12) Patent Application Publication
(10) Pub. No.: US 2016/0332018 A1
(43) Pub. Date: Nov. 17, 2016

(54) LIGHT EMITTING HOOP

(71) Applicants: Dane Granat, Buffalo Grove, IL (US); Derek Granat, Buffalo Grove, IL (US)

(72) Inventors: Dane Granat, Buffalo Grove, IL (US); Derek Granat, Buffalo Grove, IL (US)

(21) Appl. No.: 14/713,859

(22) Filed: May 15, 2015

(51) Int. Cl. A63B 19/00; H05B 33/08; H05B 37/02; F21L 4/02; F21V 23/00

(52) U.S. Cl. CPC A63B 19/00; F21L 4/02; F21V 23/009; H05B 37/029; H05B 33/0842; F21Y 2103/022

(57) ABSTRACT

An approach for creation of a hoop with a tube portion and coupling portion having a plurality of LEDs in the hoop controlled via a controller and able to accept different types of power supplies.

### 1. FIELD OF THE INVENTION

This application relates to the field of toys and more particularly to electronic toys.

### 2. BACKGROUND

Hoops have been used as toys for many years with the most commonly known hoop being the Hula Hoop. Native Americans used hoops in their “Hoop Dance” for centuries as a form of storytelling dance incorporating anywhere from one to thirty hoops as props. These props where used to create both static and dynamic shapes, which represent various animals, symbols, and stotytelling elements. The dance is generally performed by a solo dancer with multiple hoops. There was also a “craze” of using wooden and metal hoops in 14th-century England with reports that doctors treated patients suffering from pain and dislocated backs due to hooping—and heart failure was even attributed to it.

The modern hula hoop was invented in 1958 by Arthur K. “Spud” Melin and Richard Knerr, but children and adults around the world have played with hoops, twirling, rolling, and throwing them throughout history. Hula hoops for children generally measure approximately 71 centimeters (28 in) in diameter, and those for adults around 1.02 meters (40 in). Traditional materials for hoops include willow, rattan (a flexible and strong vine), grapevines and stiff grasses. Today, they are usually made of plastic tubing.

In more recent times, batteries and lights have been placed within hoops to allow use in darkened environments. But, often these modifications resulted in problems with placement and alignment of the power supply or batteries along with limitations of static lighting. Additionally, there are problems with noise created by electrical components placed in the hoop that is undesirable.

What is needed in the art is an approach for creating a dynamic lighting in a hoop while securing the power supply.

### SUMMARY

In accordance with one embodiment of the disclosure, an approach for securing tubes in a manner that creates a hoop that is able to secure a power supply in the hoop and assist in providing guidance in the proper terminal placement of the power supply for powering lights and electronics in the tube. Further the secured tube may be lighted with “intelligent” lighting that is responsive to the movement of the tube.

The above described features and advantages, as well as others, will become more readily apparent to those of ordinary skill in the at by reference to the following detailed description and accompanying drawings. While it is desirable to provide a power supply secured in a tube with “intelligent” lighting, the teachings disclosed herein also extend to those embodiments which fall within the scope of the appended claims, regardless of whether they accomplish one or more of the above-mentioned advantages.

### BRIEF DESCRIPTION OF THE DRAWINGS

FIG. 1 is an exemplary depiction of a tube portion and a coupling portion of hoop in accordance with an example implementation of the invention;

FIG. 2 is an exemplary depiction of a string of lights emitting diodes (LEDs) coupled to a power bus in accordance with an example implementation of the invention;

FIG. 3 is an exemplary depiction of power supply contacts that may be fitted into the coupling portion of the hoop of FIG. 1 in accordance with an example implementation of the invention;

FIG. 4 is an exemplary depiction of the power supply contacts of FIG. 3 in the coupling portion of FIG. 1 in accordance with and example implementation of the invention;

FIG. 5 is an exemplary depiction of the power supply contacts in the coupling portion of FIG. 3 with a controller coupled to a power bus in accordance with and example implementation of the invention;

FIG. 6 is a depiction of a top view of the coupling portion of the tube portion of FIG. 1 in accordance with an example implementation of the invention;

FIG. 7 is a depiction of a side view oldie coupling portion secured with a rivet 612 to the tube portion of FIG. 1 in accordance with an example implementation of the invention;

FIG. 8 is an example depiction of the tube portion of FIG. 1 and coupling portion of FIG. 5 in accordance with an example implementation of the invention; and

FIG. 9 is a flow diagram of an approach for operation of the hoop made up of the tube portion of FIG. 1 and coupling portion of FIG. 5 in accordance with and example implementation of the invention.

### DESCRIPTION

An example embodiment of a hoop having an internal power supply and lights responsive to the movement of the hoop is described.

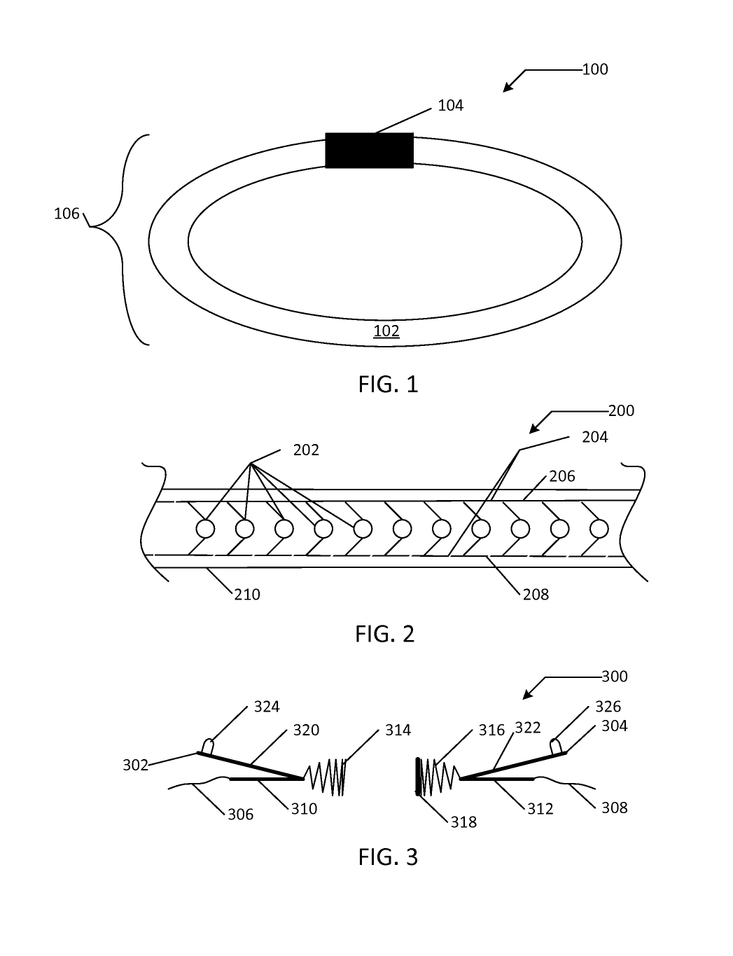

In FIG. 1, an exemplary depiction 100 of a tube portion 102 and a coupling portion 104 of a hoop 106 is shown in accordance with an example implementation of the invention. The tube portion 102 may be composed of any opaque or clear plastic material that is stiff enough to hold its shape as the hoop 106 when spun. The plastic material is typically a synthetic or semi-synthetic organics that are malleable and can be molded, such as moldable polymers, such as Polyethylene or Polypropylene. The tube portion 102 being molded and having two ends with a hollow interior that is capable of holding lights and wiring. The coupling portion 102 may have a larger diameter opening than the tube portion 102 and connects via insertion of the two ends of the tube portion 102 into the coupling portion 102 forming the hoop 106.

Turning to FIG. 2, an exemplary diagram of a string 200 of lights emitting diodes (LEDs) 202 coupled to a power bus 204 is depicted in accordance with an example implementation of the invention. Light emitting diodes are a light source and may be selected so that they are visible through the tube material. An example of the type of LED that may be used is DMPT-53782R-05RBG-BM-C manufactured by Demo Photoelectric Technology (Wuxi) Co., Ltd, LEDs typically have a positive lead and a negative lead. The LEDs 202 have their positive lead coupled to a positive portion 206 of a power bus 204 and their negative lead coupled to the negative portion 208 of the power bus 204. The power bus 204 may employ 24 AWG copper wires in the current example. The leads 206 and 208 of power bus 204 may be coupled to the positive and negative contacts of a power supply to light or be coupled to a controller. Furthermore, the LEDs 202 and power bus 204 may be wrapped in a clear plastic wrap 210 to protect the components and reduce noise in the tube. Noise in the tube portion 102 may be reduced by preventing the power bus 204 wires and LEDs 202 from hitting the sides of the hoop 106 when the hoop 106 is in motion. In other types of implementations different types of LEDs may be used, such as tri-color, or bi-color LEDs. In yet other implementations, multiple busses of LEDs may be employed and controlled by a controller. In the current example implementation LEDs were depicted, but in other implementations traditional light bulbs may be employed or other light emitting devices.

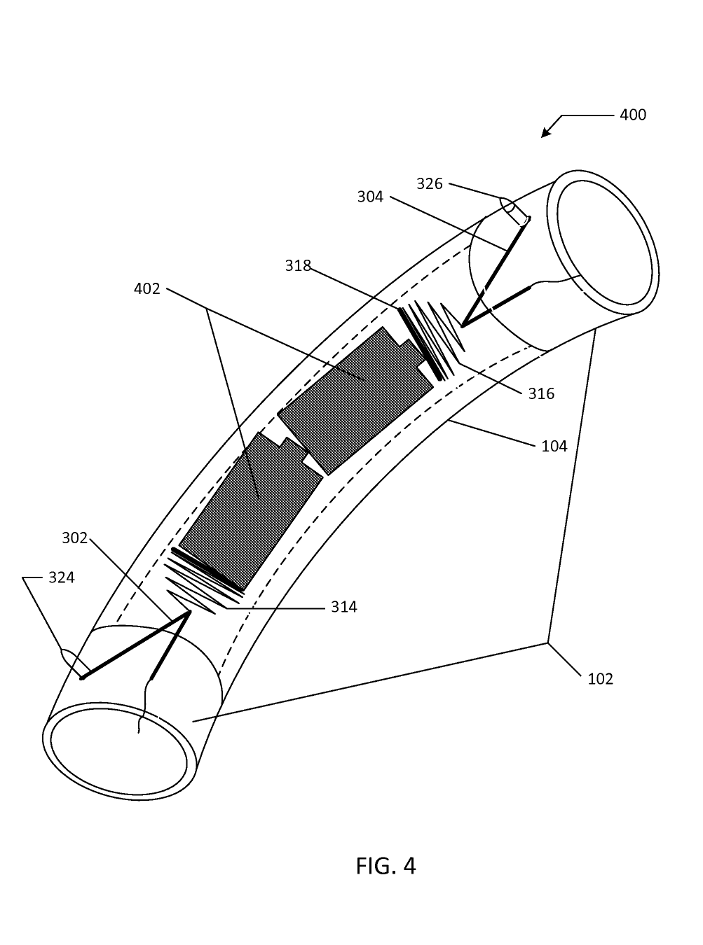

In FIG. 3, an exemplary diagram 300 of power supply contacts (left power supply contact 302 and right power supply contact 304) that may be fitted into the coupling portion 104 of the hoop 106 of FIG. 1 is depicted in accordance with an example implementation of the invention. The contact may be coupled to a lead (306 or 308) from the power bus 204 via a metal portion (310 or 312) that is coupled to a spring (314 or 316). The spring that is to contact the positive portion of a traditional battery may have an additional metal contact 318 to aid in contacting the raised portion of the battery terminal (traditionally the positive terminal on an AA, AAA, C, and D type batter). A flexible member (320 or 322) may be biased away from the metal portion (310 or 312 respectively), such that pin 324 or 326 are pushed up with an upward force. In the current implementation, the metal portion and the flexible member may be a single bent piece of metal (310 and 320, 312 and 322). In other implementation 310, 320 and 324 of the left power supply connector 302 may be a single molded piece of plastic with metal contacts connecting the spring 314 to the bus lead 306. A similar configuration may be done for the right power supply connector 304.

Turning to FIG. 4, an exemplary drawing 400 of the power supply contacts 302 and 304 of FIG. 3 in the coupling portion 104 of FIG. 1 is depicted in accordance with and example implementation of the invention. Two batteries 402 are the power supply in the current example and make contact with both power supply contacts 302 and 304. The pins 324 and 326 extend through the coupling, portion 104 and the tube portion 102 securing the tube portion 102 and the coupling portions 104 together. In the current implementation, the securing also may function as a switch and caused the springs 314 and 316 (metal plate 318) to be biased against the batteries 402, thus closing a circuit.

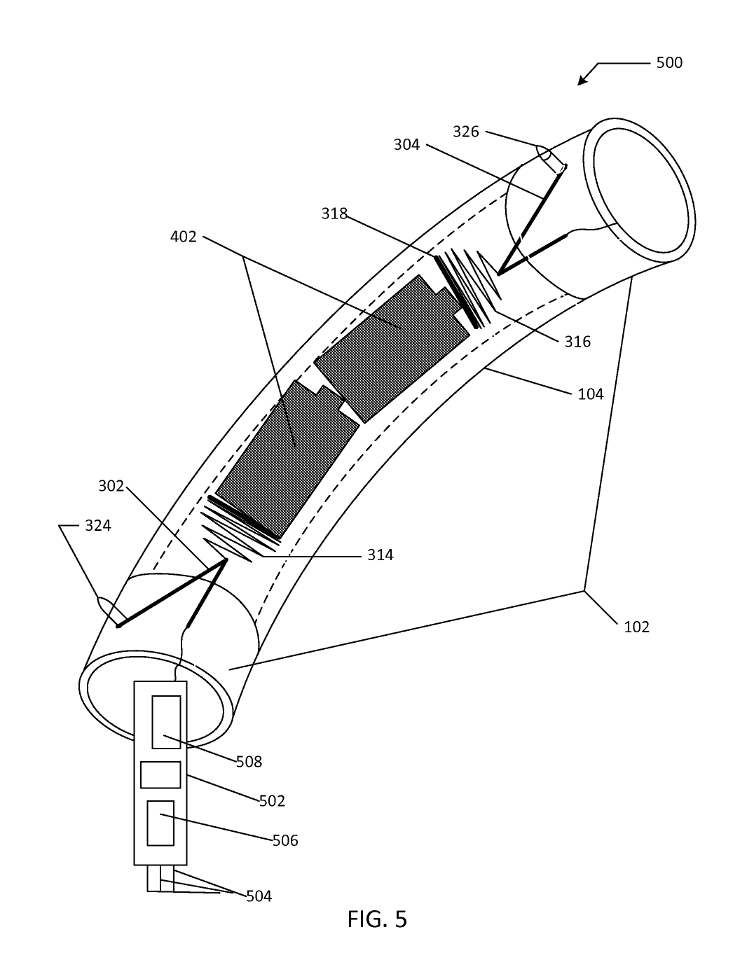

In FIG. 5, an exemplary diagram 500 of the power supply contacts 302 and 304 in the coupling portion 104 of FIG. 3 with a controller 506 coupled to a power bus 504 is depicted in accordance with and example implementation of the invention. The controller 506 may be a microcontroller, such as an Atmel AVR microcontroller, Atmel ARM processor, that has internal memory or microprocessors that may have external memory 508 in addition to internal memory and may be coupled to a circuit board 502. The controller 506 may be programed to control the light emitting diodes. Further, the controller 506 may be implemented as a group of components that include the external memory 508. Thus, the lighting pattern and the lighting of the LEDs may be controlled via predefined lighting programs stored in memory. The predefined lighting programs executed by the controller 506 may control when LEDs are turn on, off, brightness, and color. Thus, the controller 506 provides and regulates power throughout the power bus 204 and provides the programming and timing to the LEDs.

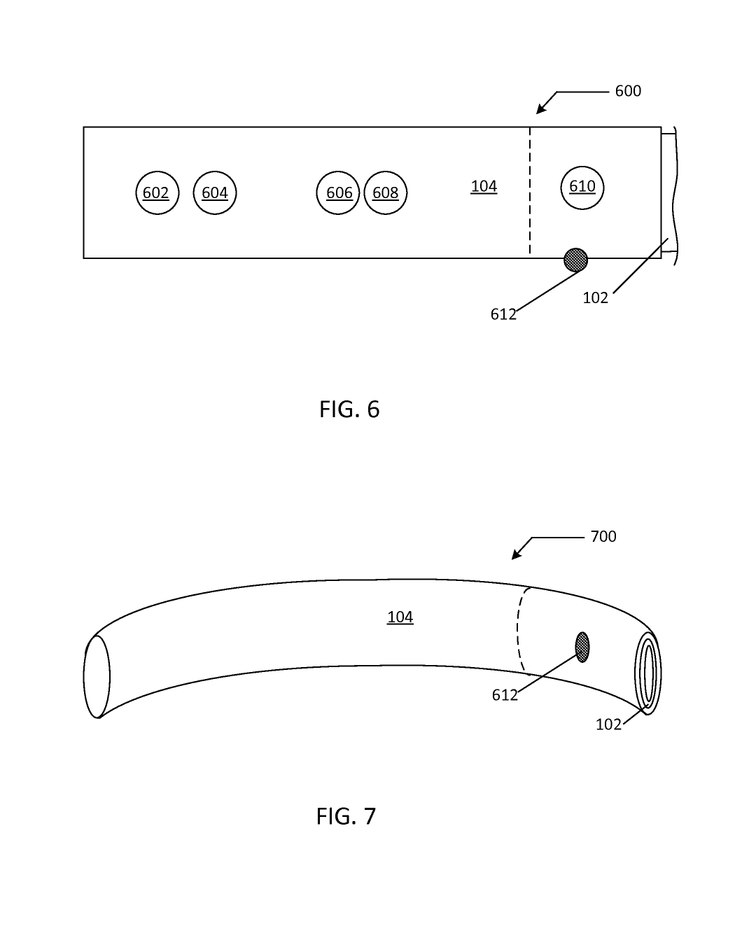

Turing to FIG. 6, a diagram of a top view 600 of the coupling portion 104 of the tube 102 of FIG. 1 is depicted in accordance with an example implementation of the invention. A first plurality of holes 602 and 604 along with a second plurality of battery holes 606 and 608 along battery hole 610 allows for multiple battery options. Thus, the coupling tube has five holes, one positive 610 and four negative holes (two on 606 and 608, two off 602 and 604). In other words, there is a first stop position 606, second stop position 608 and one or more of positions 602 and 604. These holes are sized to allow for one single batter, such as a single rechargeable battery or two everyday AA batteries. Further, to secure the connection, and prevent any shortages from occurring, the positive side of the coupling portion 104 is secured to the tubing portion 102 using a rivet 612. This rivet not only protects and secures the battery connection, but also marks the positive side of the hoop 106. If the voltage is reversed, the LEDs and/or controller may be damaged. In FIG. 7, a diagram 700 of a side view of the coupling portion 104 secured by a rivet 612 to the tube portion 102 of FIG. 1 is depicted in accordance with an example implementation of the invention.

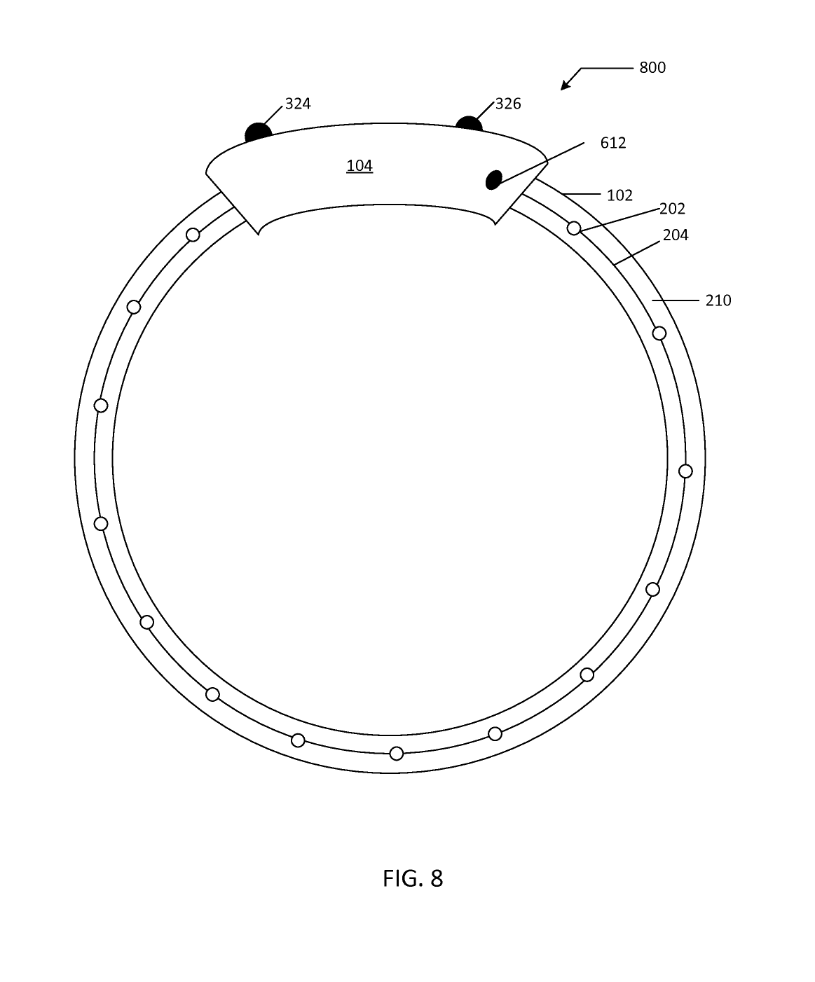

In FIG. 8, an example diagram 800 of the tube portion 102 of FIG. 1 and coupling portion 104 of FIG. 5 is depicted in accordance with an example implementation of the invention. The tube portion 102 and coupling portion 104 are permanently held together via, a rivet 612 on one end of the coupling portion in addition to the pin 326. The other end of the coupling portion 104 and tube 102 are held removable held together by pin 324. In other implementation, other permanent of semi-permeant fasteners or fastening approaches may be employed in place of a rivet, such as glue, screws, dowels, fixed pins, screw connection, to name but a few. In other implementations, pin 324 and may be replaced with other types of temporary fasteners, such as clamps, barbs, or other structures that are temporary in operation.

The LEDs 202 and power bus 204 are preferable wrapped or encased in clear plastic in side of the tube portion 102. In other implementations, different color plastic 210 may be used with clear LEDs in order to change the color of the tube portion 102. In yet other implementations, the coupling portion 104 may be clear and have one or more LEDs so it will appear similar to the rest of the tube portion 102 when lit.

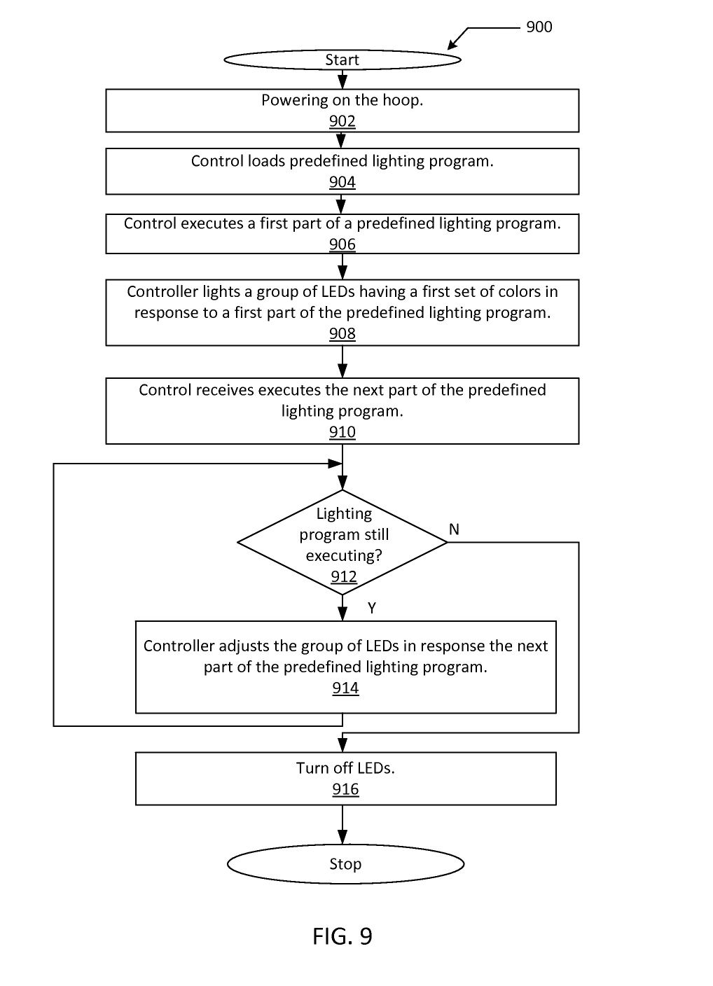

Turning to FIG. 9, a flow diagram 900 of an approach for operation of the hoop made up of the tube portion 102 of FIG. 1 and coupling portion 104 of FIG. 5 in accordance with and example implementation of the invention. The flow diagram 900 starts with the hoop being powered on by moving the coupler portion 104 from an off position to a first position engaging the power supply and powering up the controller 506 in step 902. The controller 506 loads a predefined lighting program 904 for execution by the controller 506 in step 906. The controller 506 in response to the execution of a first part of the predefined lighting program, lights a first set a group of LEDs having a first set of colors in step 908. The controller 506 executes the next part of the predefined lighting program in step 910. If the next part of the predefined lighting program is not the end of the predefined lighting program in step 912, then the controller 506 adjusts the group of LEDs and color of the LEDs in response to the next part of the predetermined lighting program in step 914. Otherwise, the predetermined lighting program is finished in step 912 and the controller 506 turns the LEDs off in step 916.

It will be understood, and is appreciated by persons skilled in the art, that one or more processes, sub-processes, or process steps described in connection with FIG. 9 may be performed by hardware and/or software (machine readable instructions). If the approach is performed by software, the software may reside in software memory (not shown) in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog from such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), as RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for light emitting hoop has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

1. A hoop, comprising:
a plurality of lights coupled to a power bus;
a tube with a first end and a second end, where the plurality of lights and the power bus are located in the tube; and
a coupler that is permanently attached to the first end of the tube with a fastener, where the fastener indicates a voltage of a power supply that supplies power to the power bus and the coupler has at least two positions that represent two different voltages.

2. The hoop of claim 1, where the fastener is a rivet.

3. The hoop of claim 1, wherein the hoop includes a controller coupled to the plurality of lights that controls at least if each of the lights in the plurality of lights is turn on or off individually.

4. The hoop of claim 1, wherein the hoop includes a wrap that is wrapped around the plurality of lights.

5. The hoop of claim 4, where the wrap is also wrapped around the power bus.

6. The hoop of claim 1, where the coupler has a first stop for a first power supply and a second stop for a second power supply.

7. The hoop of claim 1, where the coupler has an off stop position.

8. The hoop of claim 1, where the controller is a microcontroller.

9. The hoop of claim 1, where the plurality of lights are a plurality of light emitting diodes.

10. A method for lighting a hoop, comprising the steps of:
engaging a power supply by selecting a first position of a tube portion in a coupler portion from an off position to power up a controller and sensor, where the tub portion has at least a first position and a second position for engagement of the power supply;
generating sensor data with the sensor located in the hoop;
receiving the sensor data at the controller;
processing the sensor data to determine if the hoop is in motion;
lighting a group of lights by the processor in response to the sensor data indicating motion of the hoop; and
receiving additional sensor data at controller from the sensor and adjusting the group lights in response to the sensor data.

11. The method for lighting the hoop of claim 10, where the lights are wrapped in clear plastic inside of the tube portion.

12. The method of claim 10, where the controller is a microcontroller.

13. The method of claim 11, where the lights are light emitting diodes.

14. A non-transitory machine-readable medium with machine readable instructions for lighting a hoop, comprising instructions for the steps of:
booting a controller and sensor;
generating sensor data with the sensor located in the hoop;
receiving the sensor data at the controller;
processing the sensor data to determine if the hoop is in motion;
lighting a group of lights by the processor in response to the sensor data indicating motion of the hoop; and
receiving additional sensor data at controller from the sensor and adjusting the group lights in response to the sensor data.
